(19) United States
(12) Patent Application Publication
(10) Pub. No.: US 2010/0276391 A1
(43) Pub. Date: Nov. 4, 2010

(54) INDUCTIVELY COUPLED PLASMA REACTOR HAVING RF PHASE CONTROL AND METHODS OF USE THEREOF

(75) Inventors: MICHAEL N. GRIMBERGEN, Redwood City, CA (US); KEVEN KAISHENG YU, Union City, CA (US); ALAN HIROSHI OUYE, San Mateo, CA (US); MADHAVI R. CHANDRACHOOD, Sunnyvale, CA (US); VALENTIN N. TODOROW, Palo Alto, CA (US); TOI YUE BECKY LEUNG, San Jose, CA (US); RICHARD LEWINGTON, Hayward, CA (US); DARIN BIVENS, San Mateo, CA (US); RENEE KOCH, Brentwood, CA (US); IBRAHIM M. IBRAHIM, San Jose, CA (US); AMITABH SABHARWAL, San Jose, CA (US); AJAY KUMAR, Cupertino, CA (US)

Correspondence Address: MOSER IP LAW GROUP / APPLIED MATERIALS, INC., 1030 BROAD STREET, SUITE 203, SHREWSBURY, NJ, 07702, US

(73) Assignee: APPLIED MATERIALS, INC., Santa Clara, CA (US)

(21) Appl. No.: 12/748,519

(22) Filed: Mar. 29, 2010

Related U.S. Application Data
(63) Continuation-in-part of application No. 12/717,916, filed on Mar. 4, 2010.
(60) Provisional application No. 61/157,882, filed on Mar. 5, 2009.

(51) Int. Cl. H05H 1/46

(52) U.S. Cl. 216/41; 216/67

(57) ABSTRACT

Methods of operating inductively coupled plasma (ICP) reactors having ICP sources and substrate bias with phase control are provided herein. In some embodiments, a method of operating a first plasma reactor having a source RF generator inductively coupled to the first plasma reactor on one side of a substrate support surface of a substrate support within the first plasma reactor and a bias RF generator coupled to the substrate support on an opposing side of the substrate support surface, wherein the source RF generator and the bias RF generator provide respective RF signals at a common frequency may include selecting a desired value of a process parameter for a substrate to be processed; and adjusting the phase between respective RF signals provided by the source RF generator and the bias RF generator to a desired phase based upon a predetermined relationship between the process parameter and the phase.

### CROSS-REFERENCE TO RELATED APPLICATIONS

This application is a continuation-in-part of U.S. patent application Ser. No. 12/717,916, filed Mar. 4, 2010, which application claims benefit of U.S. provisional patent application Ser. No. 61/157,882, filed Mar. 5, 2009, which is herein incorporated by reference in its entirety. This application is also related to U.S. patent application Ser. No. 12/717,358, filed Mar. 4, 2010, which is herein incorporated by reference in its entirety.

### FIELD

Embodiments of the present invention generally relate to semiconductor substrate processing systems and, more specifically, to semiconductor substrate processing systems that use inductively coupled plasmas.

### BACKGROUND

Typically, plasma reactors use a radio frequency (RF) power source with a constant average power or voltage to excite a plasma in a vacuum chamber. Plasma reactors in which the RF power source is coupled to the process chamber inductively, also referred to as inductively coupled plasma (ICP) reactors, are widely used, for example, in silicon and metal etch applications. Most of these reactors have an additional RF generator coupled proximate the substrate in which plasma is coupled capacitively to the chamber. This additional RF generator is often referred to as a bias RF generator.

In some ICP reactors, the source RF generator and the bias RF generator may operate using a common exciter to force both generators to generate the same single frequency. Unfortunately, however, the inventors have observed that phase misalignment of the signals produced by the respective generators may cause problems during processing. For example, although current commercial ICP reactors try to align both source and bias signals to have zero phase difference, the actual phase difference is rarely, if ever, zero. In addition, variations in the actual phase between source and bias generators naturally exist, causing chamber-to-chamber variation in their respective phase differences. Such differences in phase within a chamber and between chambers affects the ability to provide consistent processing amongst otherwise identical chambers.

Therefore, the inventors have provided improved inductively coupled plasma reactors and methods of use as described herein.

### SUMMARY

Methods of operating inductively coupled plasma (ICP) reactors having ICP sources and substrate bias with phase control are provided herein. In some embodiments, a method of operating a first plasma reactor having a source RF generator inductively coupled to the first plasma reactor on one side of a substrate support surface of a substrate support within the first plasma reactor and a bias RF generator coupled to the substrate support on an opposing side of the substrate support surface, wherein the source RF generator and the bias RF generator provide respective RF signals at a common frequency may include selecting a desired value of a process parameter for a substrate to be processed; and adjusting the phase between respective RF signals provided by the source RF generator and the bias RF generator to a desired phase based upon a predetermined relationship between the process parameter and the phase.

Other and further embodiments are provided in the detailed description, below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of an inductively coupled plasma (ICP) reactor in accordance with some embodiments of the present invention.

FIGS. 2-8 are schematic diagrams of phase delay controllers in accordance with some embodiments of the present invention.

FIG. 9 is a schematic diagram of an inductively coupled plasma (ICP) reactor having feedback control in accordance with some embodiments of the present invention.

FIG. 10 is a schematic diagram of an inductively coupled plasma (ICP) reactor having feedback control in accordance with some embodiments of the present invention.

FIG. 11 is an illustrative flow diagram of a method for creating a table of phase versus etch parameter values in accordance with some embodiments of the present invention.

FIG. 12 is an illustrative flow diagram of a method of etching using phase control in accordance with some embodiments of the present invention.

FIG. 13 is an illustrative flow diagram of a method of etching using active phase control in accordance with some embodiments of the present invention.

FIG. 14 is an illustrative flow diagram of a method for operating a plurality of processing chambers or components using phase control in accordance with some embodiments of the present invention.

The above figures may be simplified for ease of understanding and are not drawn to scale.

### DETAILED DESCRIPTION

Embodiments of the present invention generally provide an inductively coupled plasma (ICP) reactor that is capable of control of the RF phase difference between the ICP source (a first RF source) and a substrate RF bias (a second RF source) for plasma processing reactors used in the semiconductor industry. In addition, methods of control of the RF phase difference are also provided in order to facilitate process control. For example, control of the RF phase difference may be used to control one or more of average etch rate, etch rate uniformity, etch rate skew, critical dimension (CD) uniformity, and CD skew, CD range, self DC bias (V_{DC}) control, peak RF bias (Vₚ), and chamber matching.

The inventors have observed that, because the ICP loop antenna is not truly electrically small, the currents in the loop and resulting electric fields in the chamber are not symmetric. The inventors have further observed that the addition of the various vector components can produce a field pattern that is not perfectly symmetric as a result. The inventors have discovered that, by changing the phase of the ICP loop current with respect to the bias RF, the resulting field pattern can be effectively rotated. This then changes some field components, while leaving other systematic field components unchanged. The resulting etch pattern is produced by all the components. Because various small asymmetries exist in a practical etch system, changing the phase can counteract the effect of some of these asymmetries, resulting in a more uniform etch pattern.

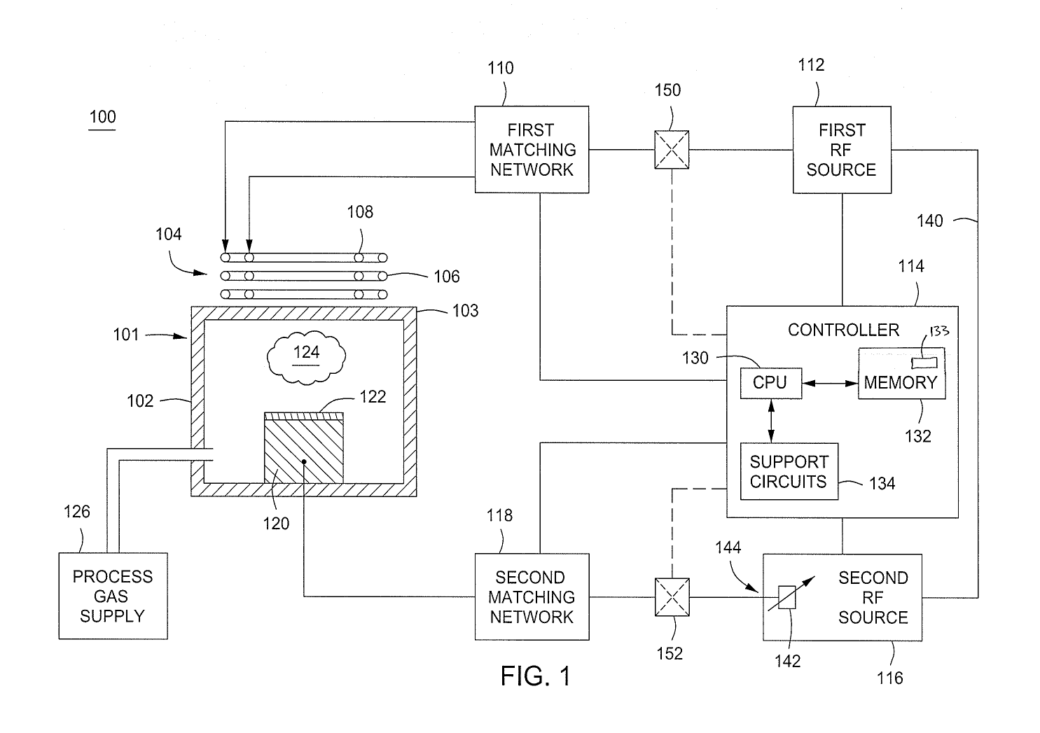

FIG. 1 is an illustrative inductively coupled plasma (ICP) reactor 100 that in one embodiment is used for etching semiconductor wafers 122 (or other substrates and workpieces, such as photomasks). Other ICP reactors having other configurations may also be suitably modified and/or utilized, in accordance with the teachings provided herein. Alternatively, the exemplary ICP reactor disclosed in FIG. 1 may be modified with portions of other ICP reactors. Examples of ICP reactors that may be modified in accordance with the teachings disclosed herein include any of the TETRA™ or DPS® line of plasma reactors available from Applied Materials, Inc., of Santa Clara, Calif.

Although the disclosed embodiment of the invention is described in the context of an etch reactor and process, the invention is applicable to any form of plasma process that uses inductively coupled RF power and an RF bias source having the same frequency. Such reactors include plasma annealing reactors; plasma enhanced chemical vapor deposition reactors, physical vapor deposition reactors, plasma cleaning reactors, and the like. In addition, as noted above, the principles discussed herein may also be used to advantage in plasma reactors having capacitively coupled RF source generators.

This illustrative reactor 100 comprises a vacuum chamber 101, a process gas supply 126, a controller 114, a first RF power source 112, a second RF power source 116, a first matching network 110, and a second matching network 118.

The vacuum chamber 101 comprises a body 102 that contains a cathode pedestal 120 that forms a pedestal or support for the substrate 122. The roof or lid 103 of the process chamber has at least one antenna assembly 104 proximate the roof 103. The antenna assembly 104, in one embodiment of the invention, comprises a pair of antennas 106 and 108. Other embodiments of the invention may use one or more antennas or may use an electrode in lieu of an antenna to couple RF energy to a plasma. In this particular illustrative embodiment, the antennas 106 and 108 inductively couple energy to the process gas or gases supplied by the process gas supply 126 to the interior of the body 102. The RF energy supplied by the antennas 106 and 108 is inductively coupled to the process gases to form a plasma 124 in a reaction zone above the substrate 122. The reactive gases will etch the materials on the substrate 122.

In some embodiments, the power to the antenna assembly 104 ignites the plasma 124 and power coupled to the cathode pedestal 120 controls the plasma 124. As such, RF energy is coupled to both the antenna assembly 104 and the cathode pedestal 120. The first RF power source 112 supplies energy to a first matching network 110 that then couples energy to the antenna assembly 104. Similarly, a second RF power source 116 couples energy to a second matching network 118 that couples energy to the cathode pedestal 120. A controller 114 controls the timing of activating and deactivating the RF power sources 112 and 116 as well as tuning the first and second matching networks 110 and 118. The power coupled to the antenna assembly 104 known as the source power and the power coupled to the cathode pedestal 120 is known as the bias power. In embodiments of the invention, either the source power, the bias power, or both can be operated in either a continuous wave (CW) mode or a pulsed mode. In some embodiments, such as is used in the TETRA™ line of processing chambers, the frequency applied is 13.56 MHz. It is contemplated that other frequencies may be used as well.

In some embodiments, a common exciter link 140 (also referred to as a CEX cable or a trigger cable) may be provided to couple the first and second RF sources 112, 116 to facilitate usage of a single RF frequency generated by one of the RF sources (the master) to be utilized by the other RF generator (the slave). Either RF source may be the lead, or master, RF generator, while the other generator follows, or is the slave. In some embodiments, the first RF source 112 is the master and the second RF source 116 is the slave. The first and second RF sources 112, 116 thus may provide respective signals having the same RF frequency (as they are generated from a single source—the master generator). However, the respective signals will be offset in time, or phase, by some intrinsic amount. This is referred to herein as the intrinsic phase difference between the signals.

In an RF etch system with two powered sources at a single frequency (or less commonly, two frequencies in which one is a harmonic), the phase between the two at the chamber is determined by a number of factors. For example, the relative phase of the two sources in the chamber can be determined by the relative phase output of the two RF generators and the RF cable length difference between each generator and the chamber. Because the propagation delay in coaxial cable is of the order of 1.55 nanosecond/foot (depending on the insulator dielectric properties), changing the one of the cable lengths can predictably change the relative phase. If one of the generators is synchronized to the other by a low-power trigger signal, than changing the length of this trigger cable also can be used to change the phase. In addition, delaying the trigger signal with a delay line or programmable delay can also control the relative phase. In a non-limiting example, for a 13.56 MHz signal, the period is 73.7 nanoseconds.

In some embodiments, the intrinsic phase difference between the first and second RF sources 112, 116 may be adjusted or controlled by changing the length of the common exciter link 140. For example, the phase change based upon the propagation delay of various cable lengths can be calculated as shown in Table 1, below. Thus, the equivalence between varying cable length and delay time to adjust phase at a fixed frequency can be established.

| | | Phase change | Phase |
|---|---|---|---|
| Cable length | Delay Time | (13.56 MHz | change |
| (ft) | (nsec) | period) | (degrees) |
| 47.5 | 73.7 | 1.0 | 360 = 0 |
| 23.8 | 36.9 | 0.5 | 180 |
| 11.9 | 18.4 | 0.25 | 90 |
| 6.0 | 9.2 | 0.125 | 45 |
| 3.0 | 4.6 | 0.063 | 22 |

In some embodiments, an adjustable delay line may be used to couple the source and bias RF generators. For example, a delay circuit 142 may be provided internally (e.g., within one of the generators) or externally (e.g., between the generators) to facilitate control of the phase difference. In the embodiment illustrated in FIG. 1, the delay circuit 142 is provided in the slave RF source (the second RF source 116). The delay circuit 142 can comprise passive components, such as a variable delay line, or active components such as a programmable digital delay. The delay circuit may provide for a zero to 360 degree delay in the signal provided to the output 144 of the slave RF source, thereby facilitating control of the phase difference of the respective signals (e.g., the phase difference between the first and second RF source may be controlled or varied from the starting point of the intrinsic phase difference between the two RF sources through any increment up to and including 360 degrees). Thus, the first and second RF sources 112, 116 may be controlled to operate in perfect synchronization, or in any desired temporal offset, or phase difference.

Optimal delay values (or phase values) for the adjustable delay line can be obtained for each chamber or for various processes performed in the particular chamber. One implementation is to create a delay circuit which is programmable and/or controllable, so that the best delay can be adjusted without hardware change. This adjustment can be made at run time or during run time, for example, as part of a process control system.

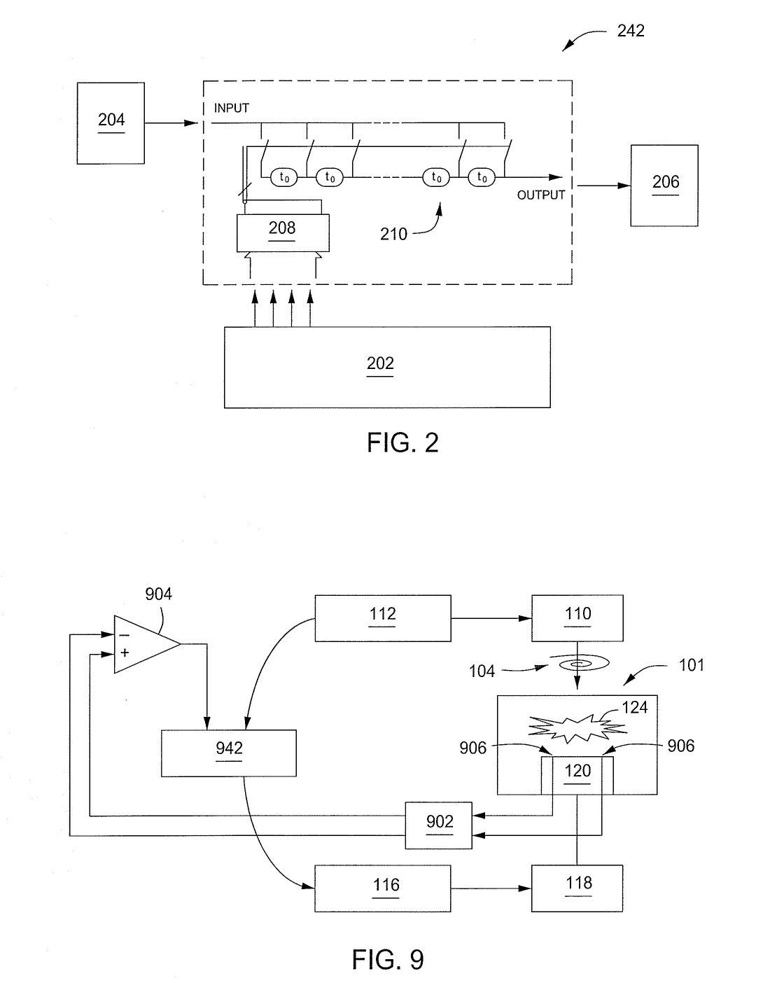

There are several methods of producing a desired delay to achieve a specific phase. For example, FIG. 2 depicts a schematic diagram of a programmable delay line in accordance with some embodiments of the present invention. For example, FIG. 2 depicts a schematic diagram of a programmable delay line integrated circuit (delay circuit 242) in accordance with some embodiments of the present invention. As shown in FIG. 2, the delay circuit 242 is programmed by an 8-bit digitized value of the desired delay time by a programming input 202. The desired delay time may be provided by the controller 114 or entered manually by an operator. The delay circuit 242 includes an internal decoder 208 that drives 255 individual digital delay elements 210 each having a desired delay time increment. The trigger output from the RF generator operating as the master provides the input trigger signal at the left (input 204). The internal decoder 208 takes the 8-bit digitized delay value and switches digital logic elements (e.g., digital delay elements 210) to provide the total desired delay between the input from the left and the output sent to the right (output 206). The output is then conditioned to the required voltage levels needed to trigger the slave generator. As such, the trigger signal received from the input 204 is delayed by the sum of the selected individual digital delay elements 210 to provide the signal having the desired delay to the output 206 of the delay circuit 242. The etch tool controller or operator supplies the digitized value of the delay time to reach the desired etch result.

In some embodiments, a coaxial cable delay box can have various lengths of coaxial cable which are switched inline by mechanical or electrical double-pole, double-throw switches. The total delay is then the sum of the lengths that have been switched inline. For example, FIG. 3 depicts an illustrative example of a switched coaxial delay line in accordance with some embodiments of the present invention. The switched coaxial delay line may be used as at least part of the delay circuit 142 shown in FIG. 1. The switched coaxial delay line includes an input 302 and an output 304 and a plurality of segments disposed therebetween (two segments 306, 308 depicted in the example of FIG. 3). A plurality of switches 310 may be provided to selectively route the RF trigger signal through zero, one, or more of the segments. Thus, the switched coaxial delay line may controllably add varying amounts of delay to the RF trigger signal traveling from the source RF generator to the bias RF generator. Each segment may be configured to provide an equal delay, or as depicted in FIG. 3, a different delay relative to each other.

In some embodiments, lumped element circuits (typically LC sections) may be provided that are designed to have the desired delay. Each section may be switched in or out, and the total delay is the sum of the lumped element delays which have been switched in. The primary advantage of the switched lumped-element delay line is to obviate the need to house long coaxial cable lengths. For example, FIG. 4 depicts an illustrative example of a portion of a lumped element delay line (as discussed below with respect to FIG. 5) in accordance with some embodiments of the present invention. FIG. 4 depicts a four section example of a lumped element delay line comprising a plurality of inductors in series and a plurality of capacitors disposed in parallel to ground. Although four inductors and capacitors are shown, greater or fewer can be used. The total delay time for this lumped element delay line is the square root of the product of total inductance times total capacitance. As such, by selecting the values of the inductors and capacitors the desired delay time can be obtained. Moreover, as shown in FIG. 5, a plurality of lumped delay lines may be coupled together in series to form a switched lumped element delay line. The switched lumped element delay line operates similarly to the switched coaxial delay line described above, except that the segments are formed from individual lumped element delay lines. Each lumped element delay line may provide the same or different time delay. Although a two-delay example is shown in FIG. 5, greater numbers of lumped element delay lines may be switched together to provide greater flexibility and granularity of control. The switched lumped-element delay line has a number of advantages: high reliability because it does not require power or signal conditioning to function, signal fidelity, wide bandwidth, and small physical size.

In some embodiments, an extended LC circuit may be provided with multiple taps. A different delay time is produced at each tap. One disadvantage of the tapped delay line is a limited number of taps, hence delay resolution. Another disadvantage is the fidelity of the waveform of the signal being delayed is affected by the tap configuration. FIG. 6 depicts a tapped delay line in accordance with some embodiments of the present invention.

In some embodiments, an LC or RC circuit may be provided in which one of the elements is varied to produce a varying phase delay. For example, a manual continuously adjustable ganged variable air capacitor can be used to change the phase from 0 to 360 degrees over a limited frequency range. Several circuits of this type can be employed to produce a delay, but the delay is frequency-specific, and the variable components must be calibrated at established positions to produce the desired delay.

In some embodiments, a programmable delay may be provided by an electronic circuit which digitally delays a pulse by the specified time, then is conditioned to whatever trigger level is needed by the RF generator. For example the delay can be created by counting a specific number of pulses from a higher frequency clock. While the accuracy and resolution can be very high, the programmable delay is more complex than passive devices.

FIG. 7 depicts a high pass/low pass filter phase shifter in accordance with some embodiments of the present invention. The circuit consists of a low-pass tee in the upper branch and a parallel high-pass tee in the lower branch. The two branches each add to the total phase shift. This circuit has the advantage of providing smaller phase error than the delay line phase shifter if the frequency is changed. For those applications in which the frequency is variable, this circuit can be advantageous. For the primary etch application, however, frequency is typically well-controlled.

FIG. 8 depicts a bridged-T equalizer delay in accordance with some embodiments of the present invention. This circuit can be constructed with resistors and capacitors (as the Z elements), but is typically used for lower frequencies.

Returning to FIG. 1, in some embodiments, a first indicator device 150 and a second indicator device 152 may be used to determine the effectiveness of the ability of the matching networks 110, 118 to match to the plasma 124. In some embodiments, the indicator devices 150 and 152 monitor the reflective power that is reflected from the respective matching networks 110, 118. These devices can be integrated into the matching networks 110, 118, or power sources 112, 115. However, for descriptive purposes, they are shown here as being separate from the matching networks 110, 118. When reflected power is used as the indicator, the devices 150 and 152 are respectively coupled between the sources 112, 116 and the matching networks 110 and 118. To produce a signal indicative of reflected power, the devices 150 and 152 are directional couplers coupled to a RF detector such that the match effectiveness indicator signal is a voltage that represents the magnitude of the reflected power. A large reflected power is indicative of an unmatched situation. The signals produced by the devices 150 and 152 are coupled to the controller 114. In response to an indicator signal, the controller 114 produces a tuning signal (matching network control signal) that is coupled to the matching networks 110, 118. This signal is used to tune the capacitor or inductors in the matching networks 110, 118. The tuning process strives to minimize or achieve a particular level of, for example, reflected power as represented in the indicator signal.

The controller 114 comprises a central processing unit (CPU) 130, a memory 132 and support circuits 134. The controller 114 is coupled to various components of the reactor 100 to facilitate control of the etch process. The controller 114 regulates and monitors processing in the chamber via interfaces that can be broadly described as analog, digital, wire, wireless, optical, and fiber optic interfaces. To facilitate control of the chamber as described below, the CPU 130 may be one of any form of general purpose computer processor that can be used in an industrial setting for controlling various chambers and subprocessors. The memory 132 is coupled to the CPU 130. The memory 132, or a computer readable medium, may be one or more readily available memory devices such as random access memory, read only memory, floppy disk, hard disk, or any other form of digital storage either local or remote. The support circuits 134 are coupled to the CPU 130 for supporting the processor in a conventional manner. These circuits include cache, power supplies, clock circuits, input/output circuitry and related subsystems, and the like.

Processing data 133 is generally stored in the memory 132. For example, process instructions, such as etching or other process instructions, stored in the memory 132 as a software routine, typically known as a recipe, may comprise a portion of the processing data 133. The software routine may also be stored and/or executed by a second CPU (not shown) that is remotely located from the hardware being controlled by the CPU 130. The software routine, when executed by CPU 130, transforms the general purpose computer into a specific purpose computer (controller) 114 that controls the system operation such as that for controlling the plasma during the etch process. Although the process of the present invention is discussed as being implemented as a software routine, some of the method steps that are disclosed therein may be performed in hardware as well as by the software controller. As such, the invention may be implemented in software as executed upon a computer system, and hardware as an application specific integrated circuit or other type of hardware implementation, or a combination of software and hardware.

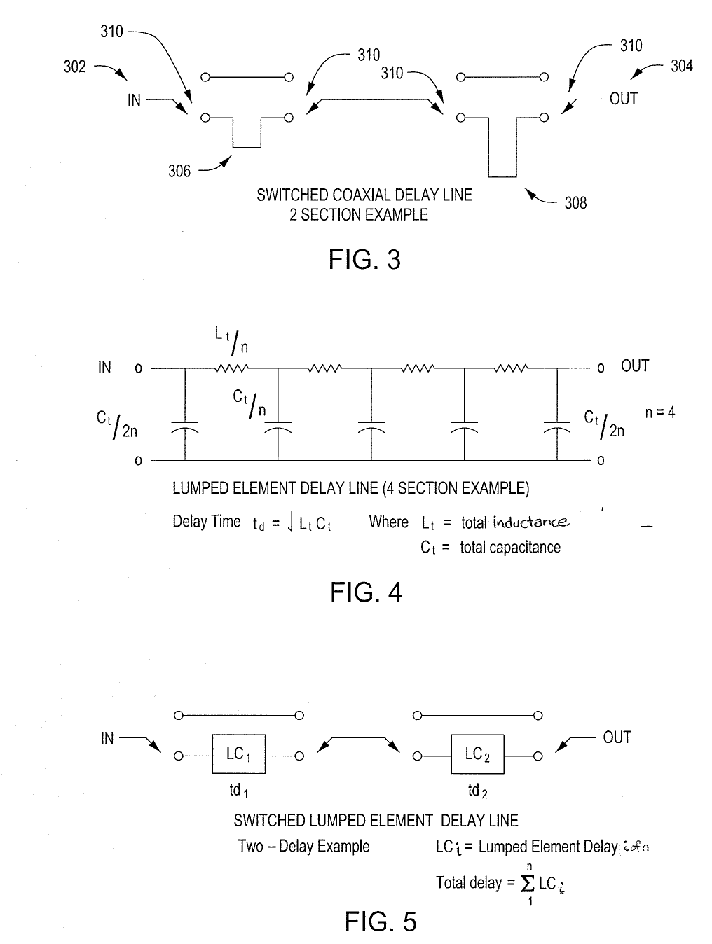

In some embodiments, multiple etch rate and/or plasma monitoring signals derived from fiber-optic sensors at different locations within the workpiece may be used to obtain data that may be used to control the phase and, thereby, to control processing within the chamber. For example, FIG. 9 depicts a schematic diagram of an inductively coupled plasma (ICP) reactor having feedback control in accordance with some embodiments of the present invention. As shown in FIG. 9, sensors located on the support pedestal 120 on either side of a photomask or wafer (e.g., substrate 122) may be used to send a differential signal to dynamically adjust the phase for best uniformity or desired etch rate in an etch chamber. A fiber optic sensor 902 may receive signals from two or more fiber optic cables 906 disposed in desired locations of the support pedestal 120 beneath the substrate. The signal from the fiber optic sensor 902 may be routed to a sensor feedback control 904 that provides a control signal to a phase delay module 942 (similar to delay circuit 142).

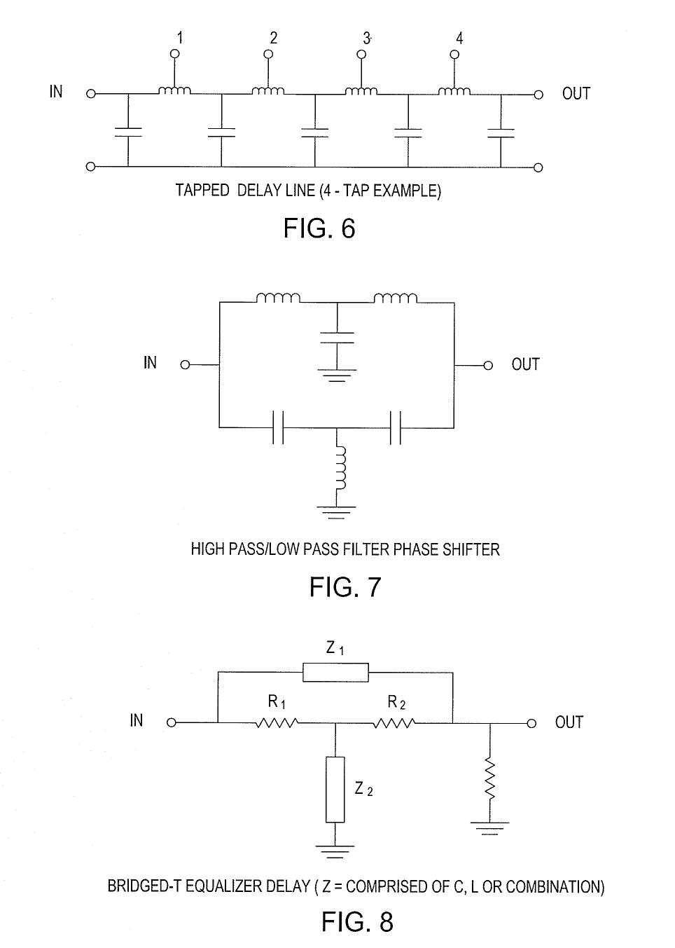

In some embodiments, the controller 114 may receive signals from a plasma monitoring device (e.g., a plasma monitor) and control the phase delay in response. For example a window 1010 may be provided in the vacuum chamber 101, as Shown in FIG. 10. A plasma monitor comprising a fast-response optical detector may be provided to detect plasma emitted radiation from within the vacuum chamber and configured to compare the phase with those of the RF generators. In some embodiments, the optical detector may provide a signal to adjust the phase of one generator relative to another. For example, a fiber optic cable 1008 may be optically coupled to the window 1010 to route signals representative of plasma emissions to the controller 114. In some embodiments, a fast amplifier 1002 may be provided to amplify the signals. In such embodiments, the controller 114 may further comprise an optical detector and analyzer for analyzing the optical signals and converting such signals to digital signals suitable for use by the controller 114 to control the phase delay circuit 142. The optical signal may be able to resolve the phase from the emission in order to provide the signal for control. The controller 142 may also be coupled to a directional coupler 1004 coupled to the output of the RF generator 112 and to a directional coupler 1006 coupled to the output of the RF generator 116 to verify the RF output of both the RF generator 112 and the RF generator 116.

The inventors have discovered that the phase difference between the source generator and the bias generator may be adjusted to minimize etch non-uniformity, including but not limited to side-to-side etch variations, and obtain the best etch uniformity. The inventors have further discovered that, in some embodiments, the phase can be adjusted by changing the length of the RF synchronizing cable (e.g., common exciter link 140) to a new length. For example, the best length has been found for the TETRA™ III chamber chromium (Cr) etch process for fabricating photomasks. This desired length was determined empirically by measuring the phase offset between existing generators, and measuring the side-to-side etch contributions for different lengths (phases). An RF cable with this specific length can then be used to couple the RF generators of the chamber to provide the desired phase difference.

In some embodiments, a semiconductor processing system may be provided having two or more similarly configured inductively coupled plasma reactors (e.g., configured similar to the inductively coupled plasma (ICP) reactor 100 described above) in a matched state. As used herein a matched state includes matching to within +/−10 percent or, in some embodiments, to within +/−5 percent or better. For example, a first plasma reactor may be matched with a second plasma reactor and optionally with up to N plasma reactors. Each plasma reactor may be configured similarly to the inductively coupled plasma (ICP) reactor 100 described above. Accordingly, each plasma reactor will have an intrinsic phase difference between their respective first and second RF sources (e.g., between their respective source and bias RF generators). Each intrinsic phase difference may be the same or different, but will likely be different due to the natural variation in the manufacture and assembly of the respective systems.

Thus, any one of the plasma reactors may include a vacuum chamber, a first RF source for providing a first radio frequency (RF) signal at a first frequency that is inductively coupled to the vacuum chamber (e.g., a source RF generator) and a second RF source generator for providing a second RF signal at the first frequency to an electrode disposed proximate to and beneath a substrate to be biased (e.g., a bias RF generator). The first and second RF sources of the given reactor provide respective signals having a first phase difference that is preset to match a second phase difference of a second plasma reactor to which the plasma reactor is matched.

The first phase difference may be preset by altering the intrinsic phase difference of between the first and second RF sources to match the second phase difference between the respective first and second RF sources of the second plasma reactor. The first phase difference may be altered with a delay circuit (such as the delay circuit 142 discussed above). The second phase difference of the second plasma reactor may be an intrinsic phase difference of that reactor, or may be some other phase difference to which the second plasma reactor is controlled.

In some embodiments, a central controller (not shown) may optionally be provided and configured to receive a first input representing a first intrinsic phase difference between the first and second RF sources of a first plasma reactor, and a second input representing a second intrinsic phase difference between the first and second RF sources of a second plasma reactor. The central controller is further configured to calculate a phase offset between the first intrinsic phase difference and the second intrinsic phase difference. Alternatively, the central controller may be configured to receive an input representing a phase offset, for example, that is calculated in a different controller or manually.

The central controller may be similar to controller 114 described above and may be a controller of a plasma reactor or may be a separate controller that is also coupled to the plasma reactor. The central controller may be configured to receive the first and second inputs, or the phase offset input, in any suitable manner, such as manually entering data, automated collection and input of the data inputs, or combinations thereof.

In some embodiments, the central controller is further configured to control a delay circuit in the second plasma reactor to apply the phase offset to the second intrinsic phase difference to create a phase difference that is equal to the first intrinsic phase difference. Alternatively, two or more of the plasma reactors may have respective phase offsets applied to modify their respective intrinsic phase differences to match a desired phase offset. As such, one or more (including all) plasma reactors that are to be matched may have phase differences that are matched to an existing intrinsic phase difference of any one of the plasma reactors or to some other desired phase difference.

Although the central controller is discussed above as a separate controller, each individual controller in each plasma reactor may be configured as discussed above without the need for the central controller. As such, any one or more of the capabilities of the central controller may be provided in a controller of any one or more of the plasma reactors.

### Phase Optimization

In general, the phase may be considered optimized when a target value of a process parameter (such as an etch parameter) is either met or closest to the desired target value for some phase setting. In practice, this can be achieved, for example, by etching several photomasks or substrates, each at a different phase setting. The etch parameter to be optimized is then measured for each etched part to create a table or trend with regard to the phase settings. The table can be analyzed by interpolation fitting or similar methods to determine the optimum phase setting to achieve the target value. One example of a desired target value would be to minimize the global CD etch uniformity (defined as the standard deviation of the critical dimension measurements across a large etch area, such as the area of the etched surface of the substrate). Illustrative CD target values include the final (post-etch) CD uniformity, the etch bias (difference between pre- and post-etch) CD uniformity, side-to-side critical dimension uniformity (or skew), or top-to-bottom critical dimension uniformity (or skew). For example, side-to-side skew may be characterized by calculating the CD difference between measurements at the left edge of the etched substrate with those at the right edge. Side-to-side skew can also be regarded as the left-right difference of the etch bias. The skew need not be necessarily left-right, but can be any orientation, including top-bottom as viewed from above.

Two other examples of etch parameters with target values are etch rate, and etch selectivity. Etch selectivity is the ratio of the etch rates of the material being etched to the etch rate of another material present, such as its overlying pattern-masking layer, or to an exposed underlying layer or portion thereof. The optimum phase is then selected by interpolating the table of either the measured etch rate or etch selectivity at several phase settings to match the desired value. In some embodiments, the optimum phase setting may be the same for similar chambers, once the component differences between the chambers have been accounted for with an offset unique to each chamber. In some embodiments, there may be subtle chamber differences in, for example, CD etch pattern, which can be further improved by further adjusting or controlling the phase on a particular chamber.

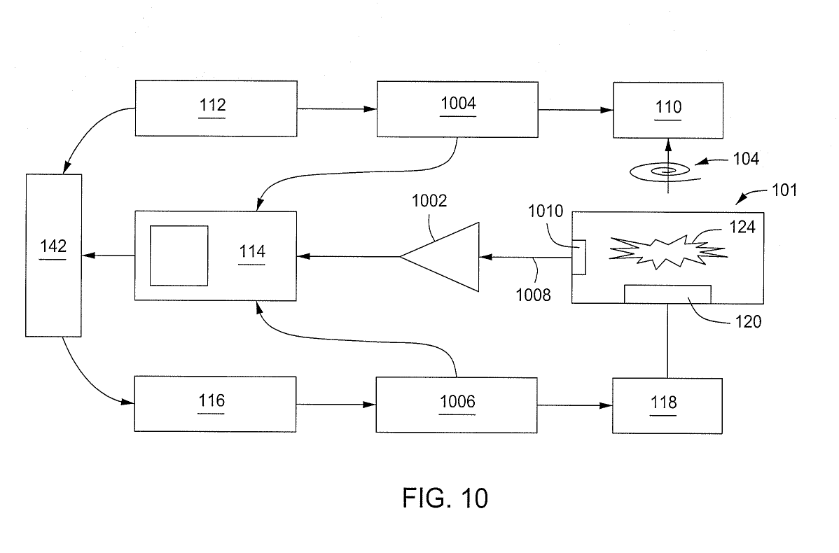

For example, FIG. 11 depicts an exemplary flow diagram of a method 1100 for creating a table of phase versus etch parameter values in accordance with some embodiments of the present invention. The method 100 may also be used for other non-etch plasma processes where phase may affect plasma properties, and therefore, processing results. The method 100 generally begins at 1102, where an initial table of phase versus etch parameter values is established. The table may be stored in a memory, for example, of the controller 114 or equivalent, or in a memory that may be accessed by the controller 114 to perform the methods as described herein. For example, the table may be stored as processing data 133 in the memory 132 of the controller 114 depicted in FIG. 1.

In some embodiments, the table may be created as shown within box 1102. For example, at 1104 the phase adjustment is set. At 1106 the substrate is etched. At 1108, the critical dimension (CD) or some other desired etch parameter is measured. At 1110, the measured result is added to the table. At 1112, it is queried whether the measured etch parameter is within a desired range. If yes, at 1114, the data table may be analyzed to establish a relationship between phase and the etch parameter for later use. If the answer is no, then the method returns to 1104 where the phase is further adjusted and the process repeated until the measured etch parameter falls within the desired range.

Once such a table of the relationship between phase and a desired process parameter is established, future substrates can be processed using phase control using either a single, predetermined optimized phase for a particular chamber and/or process, or using active phase control. Such tables can be developed for a singular process chamber type and used amongst one or more similar process chambers or the phase relationship table may be created for multiple or all process chambers to be utilized. Furthermore, such tables can be used to develop a predetermined relationship between the desired process parameter and the phase for a single process or for a plurality of processes. Non-limiting examples of such uses are described below.

### Phase Optimization by Process Application

Besides basic chamber etch characteristics that can be controlled by a single phase adjustment, individual applications may benefit from individual phase adjustments on a given chamber. A table of etch parameter values obtained at several phase settings can been measured for a specific process, yielding an optimal phase setting. Whenever this specific process is run, its specific optimized phase setting can be utilized to get the best etch results.

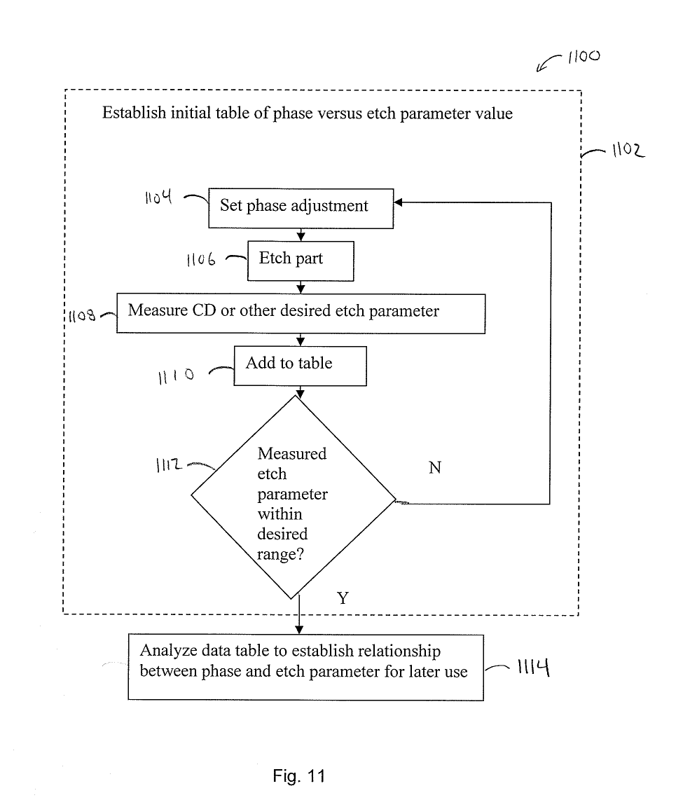

For example, FIG. 12 is an illustrative flow diagram of a method 1200 of etching using phase control in accordance with some embodiments of the present invention. The method 1200 applies to process control for other non-etch plasma processes as well. The method 1200 generally begins at 1202 where a desired etch parameter value is input into a process controller (such as process controller 114). This input may be made manually or preset as part of a process recipe. Next, at 1204, the desired phase may be determined based upon a predetermined relationship between the process parameter and the phase, for example by reference to a table of phase versus etch parameter values (such as a table created by the method 1100 described above). Next, at 1206, the desired phase is set. The desired phase may be set manually, after reference to the table, or automatically by the controller. Next, at 1208, the plasma may be started to etch the substrate until, at 1210, the phase-optimized etch is completed. As used-herein, phase-optimized means that the phase is purposefully selected to obtain desired process results based upon a predetermined relationship between phase and a desired process result, or parameter.

### Real-Time Phase Adjustment Applications for Etch Control

If a desired etch-related signal can be monitored in real-time during etching, then a control feedback loop is possible in which the phase is automatically changed to minimize the difference between the measured etch-related signal and its desired value. For example, it is known that the peak bias RF signal magnitude can be affected by the plasma generated by the source. The peak bias RF magnitude can also be changed by the phase. The phase can then be dynamically adjusted during etching to maintain a desired peak bias RF magnitude.

Similarly, if etch rate can be measured in real-time, such as described in U.S. patent application Ser. No. 11/926,417, filed Oct. 29, 2007 by Grimbergen and entitled, “ENDPOINT DETECTION FOR PHOTOMASK ETCHING,” or U.S. patent application Ser. No. 12/217,529, filed Jul. 2, 2008 by Grimbergen, et al., and entitled, “MONITORING ETCHING OF A SUBSTRATE IN AN ETCH CHAMBER,” each of which are hereby incorporated by reference in their entireties, the phase could be dynamically altered during etching to adjust the measured etch rate. This feedback method could yield a desired target average etch rate, or a depth target in a desired amount of time.

Another potential etch-related signal which can utilize phase adjustment is optical emission of the plasma. The average optical emission from the plasma may be monitored by an optical detector such as an endpoint system and the phase can be automatically varied to achieve a desired level of optical emission. More directly, a very fast optical detector can measure the time-varying emission of the plasma during an individual RF cycle and adjust the phase to maintain a pre-determined desired relationship between the emission from the source plasma and bias plasma.

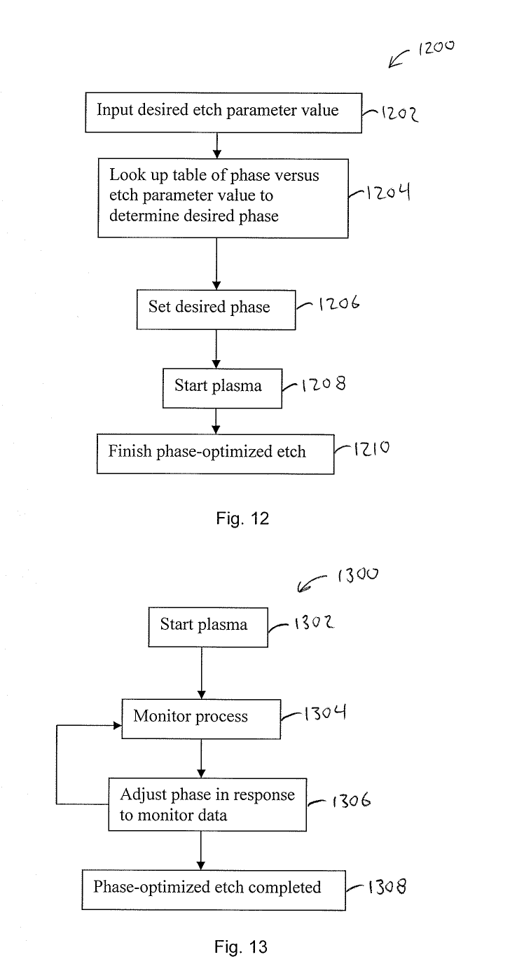

For example, FIG. 13 depicts an illustrative flow diagram of a method 1300 of etching using active phase control in accordance with some embodiments of the present invention. The method 1300 can be used with other non-etch plasma processes as well. The method 1300 generally begins at 1302 where a plasma may be started to etch a substrate. At 1304, the process is monitored, for example, using one or more of the techniques discussed above. At 1306, the phase may be adjusted in response to data provided by the monitoring at 1304. For example, the process may be monitored and the data fed back to the controller, which may then adjust the phase, or provide an adjusted phase value to be applied to the phase controller, based upon a predetermined relationship between phase and the monitored parameter. The monitoring and adjusting may repeat continuously, or periodically, until the phase-optimized etch process is completed, at 1308.

### Automated Phase Adjustment Applications

In some embodiments, the phase adjustment may be made a applied, or fixed, with respect to a process chamber prior to performing a particular process, or during fabrication and/or set-up of a process chamber to perform a particular process. However, in any of the embodiments disclosed herein, if the phase adjustment hardware is of a programmable type (e.g., certain embodiments of the delay circuit 142 discussed above), then the phase adjustment hardware can be automated with software control. Individual phase settings can be stored on the etch system for each application, for example in individual process recipes. Likewise, if a specific process step requires a particular phase setting for optimum processing or etching, then that phase setting for that individual step in a recipe can be invoked for that step only. The phase may be further adjusted during continued processing, for example, prior to or within the next step in which the desired phase is desired to be altered.

### Multiple Chamber Phase Use Applications

Because the phase adjustment can be used to adjust CD etch patterns, etch rate or selectivity, multiple chambers can each be individually adjusted to give similar performance. The invention then can remove the effects of variations between chambers due to individual component variations. For example, if RF generators have intrinsic unit-to-unit phase variability between the trigger signal and the RF output, these static phase offsets can be nullified by phase adjustment. Each chamber may then have its unique phase setting to make multiple chambers behave similarly with respect to the same etch characteristic.

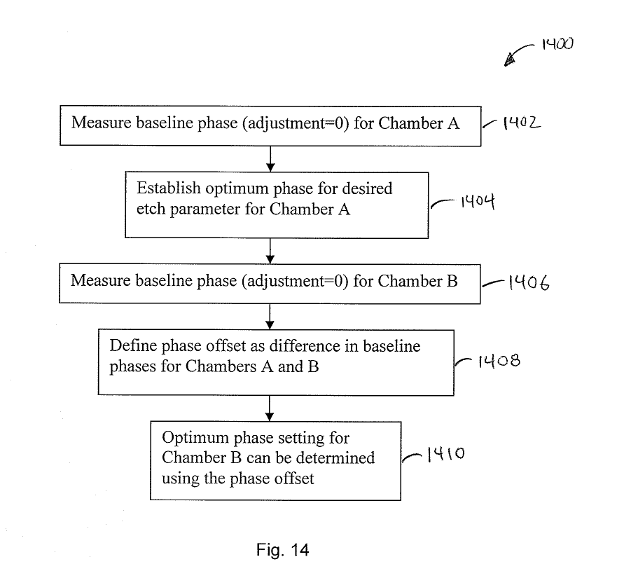

For example, FIG. 14 depicts an illustrative flow diagram of a method 1400 for operating a plurality of processing chambers or components using phase control in accordance with some embodiments of the present invention. The method 1400 is described with respect to etch chambers, but can be used with other non-etch plasma processes as well. The method 1400 generally begins at 1402 where a baseline, or intrinsic, phase is measured for a first chamber (Chamber A). The baseline phase is measured with no adjustment of the phase controller (e.g., 142) of the first chamber (e.g., the offset of the phase controller is zero). At 1404, the optimum phase may be established for a desired etch parameter for the first chamber. This may be done, for example, empirically, or using the method 1100 described above. Next, at 1406, a baseline, or intrinsic, phase is measured for a second chamber (Chamber B) that is to run the same process as the first chamber. As with the first chamber, the baseline phase is measured with no adjustment of the phase controller (e.g., 142) of the second chamber (e.g., the offset of the phase controller is zero).

Next, at 1408, a phase offset is defined as the difference in baseline phases between the first and second chambers (e.g., Chambers A and B). At 1410, the optimum phase setting for the second chamber can be determined using the calculated phase offset between the first and second chambers. For example, if the baseline phase for the first chamber is known, a phase adjustment for the first chamber is identified for a particular process, and the phase offset between the first and second chambers is also known, then the phase adjustment for the second chamber can be determined to perform the same process in the second chamber with similar results as in the first process chamber.

Therefore, in some embodiments, the phase between the second source RF generator and the second bias RF generator of the second plasma reactor may be adjusted to a desired phase in order to obtain a desired value of the process parameter for a substrate being processed in the second plasma reactor that is substantially equal to the desired value of the process parameter for a substrate being processed in the first plasma reactor. For example, in some embodiments, the process parameter may be etch rate, and the desired phase may be selected to obtain an expected etch rate of a substrate during a process to be performed in the first plasma reactor that is substantially equal to an etch rate of the substrate during the process when performed in the second plasma reactor. As used herein, substantially equal includes within +/−10 percent or, in some embodiments, to within +/−5 percent, or better.

Thus, methods and apparatus for control of the RF phase difference between a source and a bias RF generator has been provided. Such control of the RF phase difference advantageously facilitates improved process control in individual process chambers and between multiple process chambers performing similar processes.

While the foregoing is directed to embodiments of the present invention, other and further embodiments of the invention may be devised without departing from the basic scope thereof.

We claim:

1. A method of operating a first plasma reactor having a source RF generator inductively coupled to the first plasma reactor on one side of a substrate support surface of a substrate support within the first plasma reactor and a bias RF generator coupled to the substrate support on an opposing side of the substrate support surface, wherein the source RF generator and the bias RF generator provide respective RF signals at a common frequency, the method comprising:
selecting a desired value of a process parameter for a substrate to be processed; and
adjusting the phase between respective RF signals provided by the source RF generator and the bias RF generator to a desired phase based upon a predetermined relationship between the process parameter and the phase.

2. The method of claim 1, wherein the process parameter is at least one of etch rate, etch rate uniformity, etch selectivity, critical dimension uniformity, etch bias critical dimension uniformity, side-to-side critical dimension skew, or top-to-bottom critical dimension skew.

3. The method of claim 1, wherein the phase adjustment is preselected and fixed on the first plasma reactor for a plurality of processes to be performed in the first plasma reactor based upon a predetermined relationship between the process parameter and the phase for the plurality of processes.

4. The method of claim 1, further comprising:
selecting a desired value for each of a plurality of process parameters for a substrate to be processed, wherein the phase adjustment is preselected and fixed on the first plasma reactor to provide for a plurality of processes to be performed in the first plasma reactor based upon a predetermined relationship between the plurality of process parameters and the phase for the plurality of processes.

5. The method of claim 1, further comprising:
maintaining the desired phase for a process.

6. The method of claim 1, further comprising:
maintaining the desired phase for a first process step within a process.

7. The method of claim 6, further comprising:
adjusting the phase between respective RF signals provided by the source RF generator and the bias RF generator to a second desired phase for a second process step of the process.

8. The method of claim 1, wherein the source RF generator and the bias RF generator are linked by a delay circuit for varying the phase between the source RF generator and the bias RF generator, and wherein adjusting the phase further comprises:
adjusting the delay circuit to provide the desired phase using a controller coupled to the delay circuit.

9. The method of claim 8, wherein the controller is further coupled to the first plasma reactor for controlling the operation thereof.

10. The method of claim 8, wherein the predetermined relationship is stored in the controller and wherein the desired phase is determined by the controller upon input of the desired value of the process parameter.

11. The method of claim 8, further comprising:
monitoring a process as it is being performed in the first plasma reactor to obtain data; and
adjusting the phase in response to the data.

12. The method of claim 11, wherein the process is an etch process and wherein monitoring the process further comprises monitoring at least one of a bias RF magnitude, an etch rate, or an optical emission of the plasma.

13. The method of claim 1, further comprising:
adjusting the phase between respective RF signals provided by a second source RF generator and a second bias RF generator coupled to a second plasma reactor to a desired phase in order to obtain a second desired value of the process parameter for a substrate being processed in the second plasma reactor that is substantially equal to the desired value.

14. The method of claim 1, wherein the process parameter is etch rate, and further comprising:
selecting the desired phase to obtain an expected etch rate of a substrate during a process to be performed in the first plasma reactor that is substantially equal to an etch rate of the substrate during the process when performed in a second plasma reactor.

15. The method of claim 1, wherein the process parameter is etch selectivity between a primary material being etched and a masking layer disposed over the primary material.

16. The method of claim 1, further comprising:
processing a substrate in the first plasma reactor after adjusting the phase.

17. The method of claim 16, wherein processing the substrate comprises etching the substrate.

18. The method of claim 17, wherein the substrate being etched is a photomask.
